(19) United States
(12) Patent Application Publication
(10) Pub. No.: US 2025/0390416 A1
(43) Pub. Date: Dec. 25, 2025

(54) MAINFRAME CONTINUOUS INTEGRATION AND CONTINUOUS DELIVERY PIPELINE WITH CONTROLS

(71) Applicant: JP Morgan Chase Bank, N.A., New York, NY (US)

(72) Inventors: Ravi KURUGANTHY, Frisco, TX (US); Lana GLUCK, Jersey City, NJ (US); Jayaprakash MOSES, Greenville, DE (US); Raj R. GUDUR, Wilmington, DE (US); Venkata Mohit TAMANAMPUDI, New Castle, DE (US); Suman GONUGUNTLA, Wilmington, DE (US); Srinivasa ANTHAYGARI, Wilmington, DE (US); Francis Fernandes, Wilmington, DE (US); Gerald RADACK, Wilimington, DE (US); Aastha PANDEY, Wilimington, DE (US); Rajmit MANANDHAR, Wilimington, DE (US); Mani KATHARI, Wilimington, DE (US); Matthew JENKINS, New York, NY (US)

(73) Assignee: JP Morgan Chase Bank, N.A., New York, NY (US)

(21) Appl. No.: 18/896,768

(22) Filed: Sep. 25, 2024

Related U.S. Application Data
(60) Provisional application No. 63/662,981, filed on Jun. 21, 2024.

(51) Int. Cl. G06F 11/3604

(52) U.S. Cl. CPC G06F 11/3612

(57) ABSTRACT

Provided is a system that implements a mainframe continuous integration and continuous delivery (CI/CD) pipeline development, the system includes an application programming interface configured to receive data at a mainframe source code repository to enable software applications to communicate with each other via a communication network and a processor, coupled to a memory component and the API. The processor is configured to continuously monitor the mainframe source code repository for the received data to (i) detect a code commit and (ii) identify code components changed responsive to the code commit; synchronize the code commit with a distributed application source code repository; transfer the changed code components to the distributed application source code repository; and trigger, via a web hook, activation of the CI/CD pipeline in response to the transferred changed code components. The triggering occurs automatically when the changed code components are transferred to the distributed application source code repository.

### CROSS-REFERENCE TO RELATED APPLICATIONS

This application claims benefit to U.S. Provisional Patent Application No. 63/662,981, filed Jun. 21, 2024, the disclosure of which is incorporated herein in its entirety, by reference.

### FIELD OF TECHNOLOGY

The present disclosure relates to software development and deployment technologies, specifically continuous integration and continuous delivery (CI/CD).

### BACKGROUND

In the context of credit card businesses that relies on mainframe systems for processing transactions, managing customer accounts, and ensuring compliance with financial regulations, the existing software development and deployment processes are severely limited with respect to automation. This limited software development/testing and deployment automation results in slow time-to-market for new features, inefficient and error-prone processes, lack of standardization, and difficulty in compliance and auditing.

A CI/CD pipeline is a set of processes and tools used to automate software development, testing and deployment processes. CI/CD pipelines, however, are typically used to automate and streamline software development/testing and deployment tasks in distributed applications like Java and Python.

Conventional tools exist for use with some mainframe systems to simplify testing of elementary and rudimentary types of programs. For example, source control and version control tools exist for storing work associated with one portion of the code in specialized libraries. However, the conventional tools cannot fully integrate a CI/CD pipeline into a mainframe environment.

### SUMMARY

Given the aforementioned deficiencies, there is a critical need for adopting a mainframe CI/CD pipeline in a consumer & community banking (CCB) or asset wealth management environment. Implementing such a pipeline promises to address these challenges by automating the entire software development and deployment process, thus enhancing efficiency, reducing errors, ensuring compliance, and significantly speeding up the time-to-market for new features and updates. In doing so, it enables the credit card business to remain competitive, innovative, and responsive to the evolving demands of the market and regulatory environment.

As described within the context of embodiments of the present disclosure, the mainframe pipeline is a set of processes and tools used in an orchestrated manner to streamline and to automate software development, testing, and deployment for mainframe applications.

One exemplary embodiment provides a pipeline for deployment in Jules, a proprietary mainframe CI/CD pipeline. The embodiments ultimately help engineering teams deploy much faster. The embodiments also provide an ability to connect from distributed to mainframe, automating the testing software, running regression testing, and promoting the code automatically.

One embodiment includes a system that implements a mainframe CI/CD pipeline development, the system comprising an application programming interface (API) configured to receive data at a mainframe source code repository to enable software applications to communicate with each other via a communication network, and a processor, coupled to a memory component and the API, wherein the processor is configured to continuously monitor the mainframe source code repository for the received data to (i) detect a code commit and (ii) identify code components changed responsive to the code commit; synchronize the code commit with a distributed application source code repository; transfer the changed code components to the distributed application source code repository; and trigger, via a web hook, activation of the CI/CD pipeline in response to the transferred changed code components; wherein the triggering occurs automatically when the changed code components are transferred to the distributed application source code repository.

The system of any preceding clause, wherein the CI/CD pipeline includes multiple stages; and wherein the processor is further configured to segregate, at the distributed application source code repository, the code components into at least a first group and a second group, each group having different components and perform, at each of the multiple stages, a specific operation on the at least first and second groups as the at least first and second groups are transferred through the CI/CD pipeline.

The system of any preceding clause,, wherein the processor is further configured to automatically perform testing for deployment, perform an automated rollback to revert changes made to the code components when the testing fails, and establish a password-less connection throughout the CI/CD pipeline using certificate-based authentication.

The system of any preceding clause, wherein the processor is further configured to establish a password-less connection throughout the pipeline using certificate-based authentication.

The system of any preceding clause, wherein the processor is further configured to monitor code commits in a mainframe version control tool using a code commit monitor microservice.

The system of any preceding clause, wherein the processor is further configured to update the code in a distributed version control system upon detecting code commits.

The system of any preceding clause, wherein the processor is further configured to perform a code review process to compare code developed in the pipeline with existing code to determine whether a conflict exists.

The system of any preceding clause, wherein the processor is further configured to perform a unit test to test the software code components to verify that the changes to the code operate correctly before incorporating the code into a computing system.

The system of any preceding clause, wherein the processor is further configured to perform a security test to continuously inspect the software code components or the software components to identify potential threats from unauthorized access, data breaches, and other security issues.

The system of any preceding clause, wherein the processor is further configured to perform a performance test to test every functionality of the software code components or software components to verify that an application performs correctly in real-world scenarios.

Another embodiment includes an exemplary method for implementing a mainframe CI/CD pipeline, the method comprising receiving data at a mainframe source code repository via an application programming interface (API) configured to enable software applications to communicate with each other via a communication network; continuously monitoring the mainframe source code repository for the received data to (i) detect a code commit and (ii) identify code components changed responsive to the code commit; synchronizing the code commit with a distributed application source code repository; transferring the changed code components to the distributed application source code repository; and triggering, via a web hook, activation of the CI/CD pipeline in response to the transferred changed code components; wherein the activating occurs automatically when the changed code components are transferred to the distributed application source code repository.

The method of any preceding clause, establishing a password-less connection throughout the CI/CD pipeline using certificate-based authentication, and establishing a password-less connection throughout the pipeline using certificate-based authentication.

The method of any preceding clause, further comprising monitoring code commits in a mainframe version control tool using a code commit monitor microservice.

The method of any preceding clause, further comprising updating the code components in a distributed version control system upon detecting code commits.

The method of any preceding clause, further comprising performing a code review process to compare code components developed in the pipeline with existing code to determine whether a conflict exists.

The method of any preceding clause, further comprising performing a unit test to test the software code components to verify that the changes to the code components operate correctly before incorporating the code into a computing system.

The method of any preceding clause, further comprising performing a security test to continuously inspect the software code components or the software components to identify potential threats from unauthorized access, data breaches, and other security issues.

The method of any preceding clause, further comprising performing a performance test to test every functionality of the software code components or software components to verify that an application performs correctly in real-world scenarios.

Yet another embodiment includes a non-transitory computer-readable medium storing instructions that, when executed by a processor, cause the processor to implement a mainframe CI/CD pipeline, the instructions comprising receiving data a mainframe source code repository via an application programming interface (API) configured to enable software applications to communicate with each other via a communication network; continuously monitoring the mainframe source code repository for the received data to (i) detect a code commit and (ii) identify code components changed responsive to the code commit; synchronizing the code commit with a distributed application source code repository; transferring the changed code components to the distributed application source code repository; and triggering, via a web hook, activation of the CI/CD pipeline in response to the transferred changed code components; wherein the activating occurs automatically when the changed code components are transferred to the distributed application source code repository.

The non-transitory computer-readable medium of any preceding clause, wherein the instructions further cause the processor to automatically perform testing for deployment and perform an automated rollback to revert changes made to the code component when the testing fails.

The non-transitory computer-readable medium of any preceding clause, wherein the instructions further cause the processor to perform an automated rollback to revert changes made to the code components when the testing fails, and monitor code commits in a mainframe version control tool using a code commit monitor microservice.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 is an exemplary flow diagram of the mainframe CI/CD pipeline process in accordance with embodiments of the present disclosure.

FIGS. 2A-2C is a sequential flow diagram of a mainframe software development process (DevOps) in a pipeline in accordance with the embodiments.

FIG. 3 is a high-level overview of an exemplary mainframe pipeline in accordance with the embodiments.

FIG. 4A-4C is a simple flow diagram of a mainframe DevOps in accordance with the embodiments.

FIG. 5 is a block diagram of an exemplary computing device configured for implementing one or more embodiments of the present disclosure.

FIG. 6 is an exemplary code tracker service flow diagram in accordance with the embodiments.

FIG. 7 is an exemplary mainframe DevOps pipeline auto-rollback flow in accordance with the embodiments.

FIG. 8 is an exemplary mainframe DevOps pipeline infrastructure diagram in accordance with the embodiments.

FIG. 9 is a flow chart of an exemplary method of implementing an embodiment of the present disclosure.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

In today's fast-evolving digital landscape, integrating mainframe systems with DevOps practices through a mainframe pipeline is a necessity. This strategic move not only modernizes legacy systems but significantly boosts efficiency, agility, and reliability in software development and deployment processes. A mainframe pipeline automates critical workflows, minimizes human error, and accelerates the delivery of high-quality software, ensuring that businesses can keep pace with market demands while leveraging the unparalleled security and processing power of mainframes. This approach represents a crucial step towards blending the old with the new, ensuring that organizations remain competitive and resilient in the digital era.

An embodiment of the present disclosure is directed to a mainframe CI/CD design solution that provides complete end-to-end process for mainframe applications. Mainframe pipeline is a set of processes and tools used to automate software development, testing and deployment for mainframe applications. It streamlines the development workflow, promoting CI/CD pipelines in a mainframe environment. An exemplary implementation may leverage CI/CD pipelines, such as Jules, Jenkins, etc.

An embodiment of the present disclosure may be applied to distributed systems in various businesses, such as a CCB environment by establishing a CI/CD model for mainframe applications. A distributed system is a collection of computer programs that utilize computational resources across multiple, separate computation nodes to achieve a common, shared goal. Many modern applications utilize distributed systems. Some examples of distributed applications include web browsers, e-commerce websites, blockchain applications, cloud computing platforms, distributed databases, and peer-to-peer file-sharing networks.

In various embodiments, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

Various embodiments implement CI/CD pipelines for mainframe systems in CCB involves adopting best practices to ensure efficient and reliable deployment across various environments, components, and services.

Thus, one goal of the system and method is to deploy any mainframe software changes from development to testing to production in approximately less than one hour with confidence and quality, which is similar to the approach of TrueCD. In embodiments of the system and method according to the present disclosure, a new release candidate is tested and then released every time the code changes. Any change to the software can be deployed to a testing or staging environment at the click of a button. Development teams receive fast feedback from automated tests, staging environments, and production environments, and can use this feedback to drive additional improvements.

The 12 steps below are examples of best practices for distributed systems.
a) Approved pipeline
b) Unit Testing
c) Contract Testing
d) Component Testing
e) Acceptance Testing
f) End to End testing
g) Performance Testing
h) Security Testing
i) Resilience Testing
j) Blue/green Deployment
k) Production Validation Testing
l) Automated Rollback

Some of the exemplary key benefits of using a deployment pipeline for mainframe code include:
Automation. Deployment pipelines automate the process of building, testing, and deploying mainframe code, reducing manual errors and accelerating the release cycle. Through testing of functionality, security, and compliance.
Consistency. By standardizing the deployment process, pipelines ensure consistency across environments, reducing the risk of configuration drift and ensuring reliable deployments. Conducting multiple testing phases for all components and packages helps to employ a toll check for better stability. Agile methodology is embraced for development, allowing for interactive and incremental development.
Visibility is provided. That is, deployment pipelines provide visibility into the status of each stage of the deployment process, enabling teams to identify and address issues quickly.
Traceability. With deployment pipelines, tracking changes to mainframe code is easier, facilitating compliance requirements and audit trails. Specific traceability features include a rigorous change management process for code deployment; strict access controls based on roles; segregation of duties to prevent unauthorized changes; and trackability for audit and compliance purposes.
Embodiments of the present disclosure are efficient. By streamlining the deployment process, pipelines improve overall efficiency, allowing teams to focus more on development and innovation rather than manual deployment tasks.
Collaboration. Deployment pipelines promote collaboration among development, testing, and operations teams, fostering a culture of shared responsibility and continuous improvement.

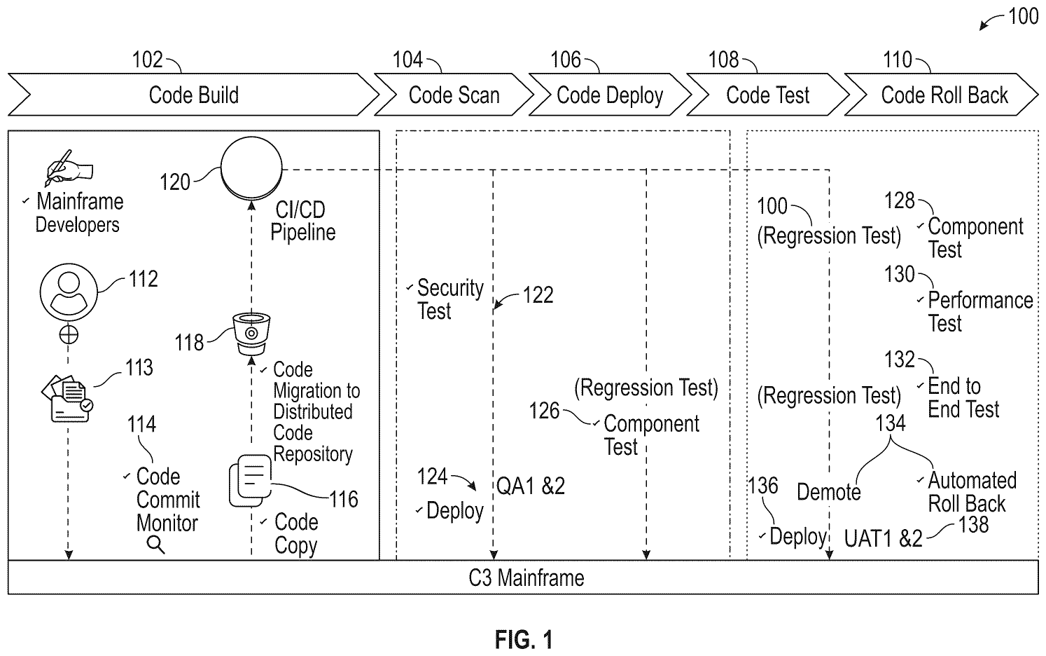

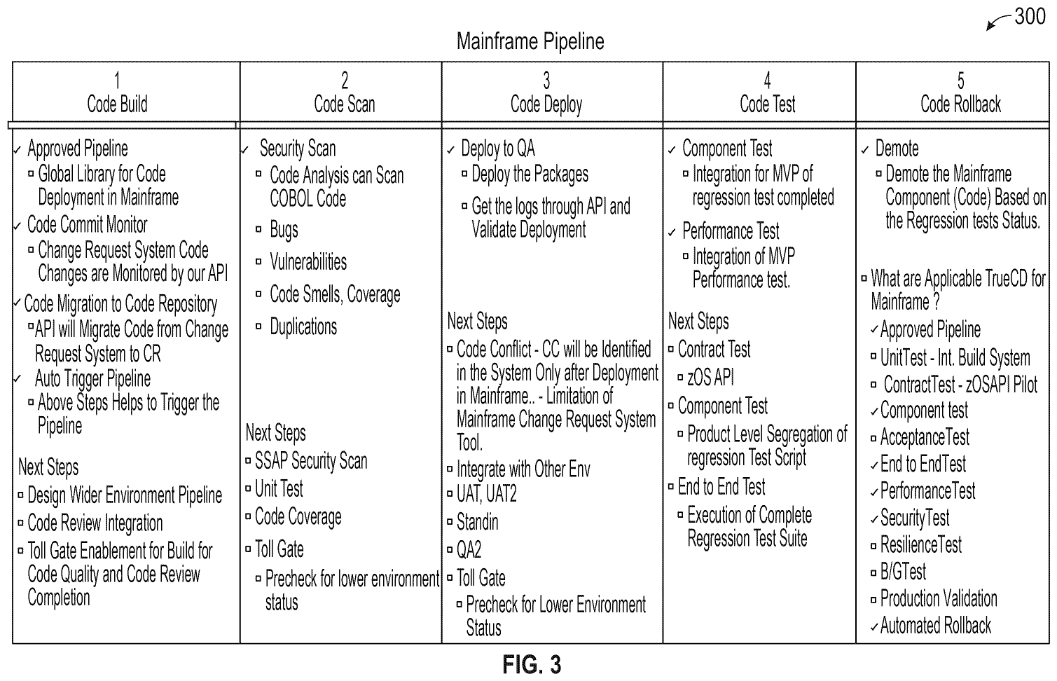

FIG. 1 is an exemplary flow diagram of the process of a mainframe CI/CD pipeline environment 100 in accordance with embodiments of the present disclosure. FIG. 1 illustrates an exemplary embodiment of an approved pipeline. Only approved pipelines are permitted to execute on the production environment. The pipeline environment 100 may include a collection of tools that may be accessed from or implemented within the pipeline environment 100 to accomplish software development, testing and deployment. The pipeline environment 100 is made up of multiple stages and steps, with each step representing a single task and each stage grouping similar steps together. The exemplary workflow as depicted in the embodiments of FIGS. 1 and 3 may include a stage 1, Code Build 102 using, for example, Jules. After stage 1, the workflow may precede to code scan 104 (stage 2), code deploy 106 (stage 3), code test 108 (stage 4), and Code Roll Back 110 (stage 5).

In the code build 102 stage, development teams 112 may be responsible for building, releasing, and integrating software for various software applications. For example, in FIG. 1, the development teams 112 are able to make use of a development toolkit. The toolkit includes a collection of libraries, such as Enterprise toolchain wherein the framework focuses on orchestrating the parts of mainframe application development that revolve around building, testing, and deploying code through a CI/CD pipeline. Also included is a mainframe source code repository 113 for receiving data from the development teams 112. The CI/CD pipeline environment 100 offers a quality assurance (QA), user acceptance testing (UAT), and an agile testing production environment including, for example, zSeries Agile Testing Environment (zATE) and Virtual Stand-in Environment (VStandin).

In an embodiment, password less connection may be provided throughout the pipeline. For example, a certificate-based password less connection to a mainframe may be employed, which involves mapping of functional ID (identity) to the certificate and the certificate used for all authentication. A functional ID is a generic account used for an IT asset, but it's not tied to a specific user. The functional IDs can provide access to different areas and access levels.

A code commit monitor 114 may be provided to automatically run tests and check on every code commit. As well understood by those of skill in the art, a code commit is a fundamental operation in version control system that records changes to the source code repository. When a developer 112 commits code, the pipeline environment 100 begins, runs tests, and deploys the service. If any test fails because the developer has introduced a bug, the pipeline detects it early and prevents the faulty code from reaching production. Embodiments of the code commit monitor 114 may include an automated change request system, such as ChangeMan and Endevor, which is a software configuration management tool used by developers 112 to manage and track changes to software development projects. ChangeMan and Endevor are mere examples; other systems and tools may be implemented.

The automated change request system of the code commit monitor 114 allows developers to manage source code changes, track project progress, and collaborate with team members on software development projects. The code commit monitor 114 may be the mainframe version of a control tool. Code commit monitor 114 may be a microservice that can monitor the CodeCommit or code staged in a distributed (applications source) code repository 118 and monitor information about each commit.

The code commit monitor 114 can be used to take other actions, such as sending notifications or storing the commit information in the distributed code repository 118, such as Bitbucket. Bitbucket is one example of a code repository system that provides a version control repository hosting service. Other repositories and management systems, such as GitHub, may be used.

Code migration to the distributed code repository 118 may be provided in an embodiment. When the code commit monitor 114 identifies the code is staged/committed, it copies code 116 and updates it in the distributed code repository 118.

Various embodiments, according to the present disclosure, provide an approach to software design that creates or edits reusable, interchangeable, independent software units, which are referred to as “components.” These components encapsulate specific functionality and interact with other components through well-defined interfaces. The interface specifies the methods and properties a component provides for others to use. This approach promotes loose coupling components that can be changed or replaced with minimal impact on the overall system. Components are often units of release and deployment in a mainframe pipeline.

This approach enables the system and method to identify all software components, libraries, and modules that are running in the environment, even their dependencies. In Unit tests, individual software code components are checked to determine if they are working as expected or not. Unit tests isolate a function or module of code and verify its correctness. Software code components within the meaning of the present disclosure are parts of a software program that perform independent tasks. They can be small modules, fragments or subsystems. Thus, various embodiments provide a process to easily maintain, deploy, update, and develop the software code components.

In an embodiment, the distributed code repository 118 can identify the components and packages that are being updated by the commit. The revised code can be segregated between different components. For example, the code components can be segregated into multiple groups, including at least a first group and a second group, wherein each group has different components. At each stage of the CI/CD pipeline, a specific operation may be performed on the segregated code components as the segregated components are transferred through the CI/CD pipeline. In embodiments, an API can be used to add artificial intelligence (AI) functionality to the system to identify and segregate the code between different components. The APIs can serve as a bridge for software developers to interact with external software components or resources. The APIs allow distinct software programs to communicate with each other.

In various embodiments, the lines of code that are being changed or revised are pulled from the mainframe source code repository 113 to detect a code commit and identify code components that have changed. The lines of code are then pushed into a distributed applications source code repository, such as Bitbucket or GitHub. For instance, the system can automatically identify, for example, just two lines out of 17 million lines of code of a component being updated. The identified component code will be pulled and pushed to the distributed code repository 118 to identify the code that needs to be promoted. The promotion copies the code into libraries for application testing or other purposes. The promotion may also be configured to execute additional processes to prepare promoted components for execution.

For example, in an embodiment, the system and method can identify a number of software code components and a respective total number of lines of code of each software component registered in a distributed system connected to the pipeline. The system and method can determine a number of revised lines of code out of the total number of lines of code of each software component that have been changed due to the code commit. The system and method can segregate the revised lines of code in the distributed code repository 118, such as a distributed version control system based on the different software components. Only the identified revised lines of code are pushed into the code repository to determine the code components that need to be promoted in the pipeline.

In the embodiments, the pushing of the code into the distributed code repository 118 triggers the activation of an exemplary mainframe CI/CD pipeline 120. By way of example only, and not limitation, the mainframe CI/CD pipeline 120 may be implemented as a Joules of Jenkins pipeline. Once the CI/CD pipeline 120 has been activated, tasks within various stages of the CI/CD pipeline 120 are streamlined and occur automatically, based on predefined events, conditions, or dependencies.

In one embodiment, a web hook may be used as the mechanism for triggering the activation of the CI/CD pipeline 120. The triggering occurs when the code is pushed into, or committed in, the distributed code repository 118. In the exemplary embodiment of FIG. 1, updating of code in the distributed code repository 118 is synchronized with the start of the development stage within the CI/CD pipeline 120. This synchronization is helpful in triggering activation of CI/CD pipeline 120.

A code review application may be provided in an embodiment. Some conventional source code management tools, such as ChangeMan, do not have a code review process. In the present disclosure, the code review app for the mainframe pipeline environment 100 compares the code developed with existing code for any conflict.

A toll gate for the pipeline trigger may be provided in an embodiment. Adding a toll gate in the pipeline environment 100 provides a strategic control point where the progression of the pipeline is conditionally paused or continued based on specific criteria being met. This gate typically ensures that only high-quality, validated code progresses through to subsequent stages. To implement a toll gate, the pipeline environment 100 is configured to require manual approvals, pass automated test results, and meet certain performance metrics before triggering the next steps in the pipeline. This approach helps maintain code quality and operational stability by preventing potentially problematic changes from moving forward automatically.

Embodiments of the present disclosure may employ a suite of various types of automated testing and testing methodologies: unit testing, security testing, component testing, performance testing, and end-to-end testing.

Unit testing may be provided in an embodiment. Unit testing is the process where the smallest functional unit of code, for example, a software code component, is tested. A software development best practice is to write software as small, functional units then write a unit test for each code unit. First, unit tests can be written as code. Then, run that test code automatically every time changes are made in the software code. This way, if a test fails, the area of the code that has the bug or error can be quickly isolated.

With unit testing, the process of testing individual components or packages of a mainframe application ensures each part of functions are correct before integrating them into the larger system. This is critical in mainframe environments due to the complex, large scale and often mission critical nature in which the application is run. Automated unit testing can be performed, for example, by Test4Z provided by vendor Broadcom.

Some advantages include:
a) Increased Reliability
b) Easier debugging
c) Improved code quality
d) Early problem detection
e) Better design
f) Regression Assurance

Security testing 122 may be provided in an embodiment. Security testing is a type of software testing that assesses the security of a system or application to identify potential threats and vulnerabilities. The goal of the security testing is to ensure that the system is protected from unauthorized access, data breaches, and other security-related issues.

As an example, SonarQube or SonarQubeDEI may be used as a security testing tool. SonarQube can be used for continuous inspection of code quality, including security vulnerability, bugs, plain text passwords, code coverage etc. SonarQubeDEI can be used as a Software Security Assurance Process (SSAP) to provide open source scanning, etc.

Deploy tools 124 may be provided in an embodiment. Testing and QA is one of the software deploy tools which help to easily integrate project changes. QA in the software development lifecycle (SDLC) refers to the process of achieving or maintaining a desired level of quality in a service or product to deliver consistent results by using agreed standard processes and procedures to ensure the software meets certain requirements before being released. One of the main objective of the CI/CD process is to quickly identify and fix or correct software errors, to improve the quality of the software and to reduce the overall time spent on checking and releasing new software updates.

Regression testing may be provided in the code deploy stage 106 and the code test stage 108. Regression testing refers to a software testing technique that re-runs tests to ensure that a software application works as intended after any code changes, updates, revisions, improvements, or optimizations.

Component testing 126, 128 may be provided in an embodiment. The code deploy stage 106 may include component testing 126 and the code test stage 108 may include component testing 128. Component testing is a level of software testing that focuses on verifying the individual components of a system. A component refers to a self-contained module or a group of related functions within the software. Component testing is a closed-box testing technique that evaluates the application without considering the code information as performed in unit testing.

Component testing 126, 128 may use, for example, SmartSpec, in the mainframe pipeline environment 100, which focuses on verifying the functionality of individual parts of the application in isolation. The component testing tool, which may be integrated into the pipeline environment 100 through plugins or scripts, allows for defining precise test-driven development (TDD) tests. These tests are designed to validate the expected behavior of components based on defined specifications. By automating component tests within the pipeline environment 100, developers can continuously assess the impact of changes, ensuring that each component meets its specifications before progressing to broader system integrations. This approach enhances the overall quality and robustness of the software.

Performance testing 130 may be used in an embodiment. Performance testing 130 ensures reliability and efficiency of the component. It involves simulating the real world usage scenarios to identify potential bottlenecks and optimize throughput and response times. For example, the performance testing 130 may be performed using Blazemeter.

End-to-End (E2E) testing 132 may be used in an embodiment. E2E testing 132 is a software testing method that tests an application's workflow from start to finish. The goal of E2E testing is to find bugs or errors that may occur when all parts of the system work together, and to ensure that the application performs as expected in real-world scenarios. In an E2E test, every functionality of the software is tested. For example, a Smartspec framework can be used in E2E testing to test every functionality of the application. When all tests are successful, E2E testing is considered successful.

Automated rollback 134 may be provided in an embodiment. The concept of automated rollback after a failed E2E test is reverting any changes made to the components during the testing process to a known stable state. Demote occurs when there is a reason to rollback to a previous release version. Demotion deletes components from libraries that were populated by promotion.

This rollback process aims to restore the functionality and prevent the deployment of faulty or incomplete changes to production. Steps involved in an E2E failure and automated rollback may include:
a) Identifying the packages/components for demotion (E2E test failure)
b) Initiate Demotion process (Triggering demote JCL (Job Control Language)) through zOS API
c) Execute the JCL in the Mainframe to revert back the package/component
d) Validation and testing (Old existing functionality): download the packages/component list and identify whether those are demoted
e) Display result in the pipeline as success or failure.

Various embodiments may employ a zOSMF deploy connector for a mainframe computer running z/OS. The pipeline environment 100 may connect to the mainframes over hypertext transfer protocol structure (HTTPS) and identify components to be promoted via a zOSMF deploy connector solution. The pipeline environment 100 promotes code to higher environments via the zOSMF deploy connector solution. The zOSMF deploy connector retrieves the System Logging Protocol (Syslog) from the mainframes and identifies return codes used for identifying overlays.

Deploying 136 to a Higher Environment may be implemented. In the pipeline environment 100, the deploying process 136 to a higher environment marks the final stage of the CI/CD process. This final deployment step involves testing and validating code to production or similar higher-level environments, ensuring it is ready for release. It is crucial for this final stage to include robust deployment strategies and rollback plans to maintain system integrity and minimize downtime.

The CI/CD is a continuous process that automatically deploys every code change that passes the CI process to production. Typically, one of the last stages of staging is UAT 138. It occurs immediately before the software goes into production. During this stage, the software is tested by the intended audience to make sure that the software can handle real-world functions and meet the user's expectation. In UAT 138, users are given the opportunity to interact with the software before its official release to determine if any features have been overlooked or if it contains any bugs or errors.

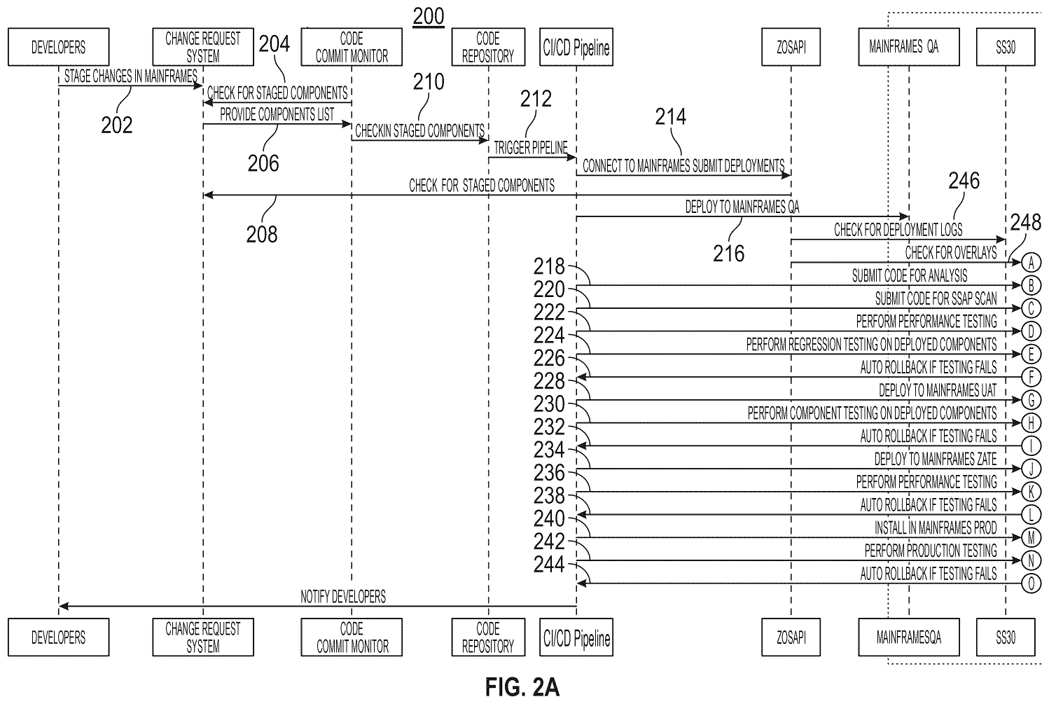

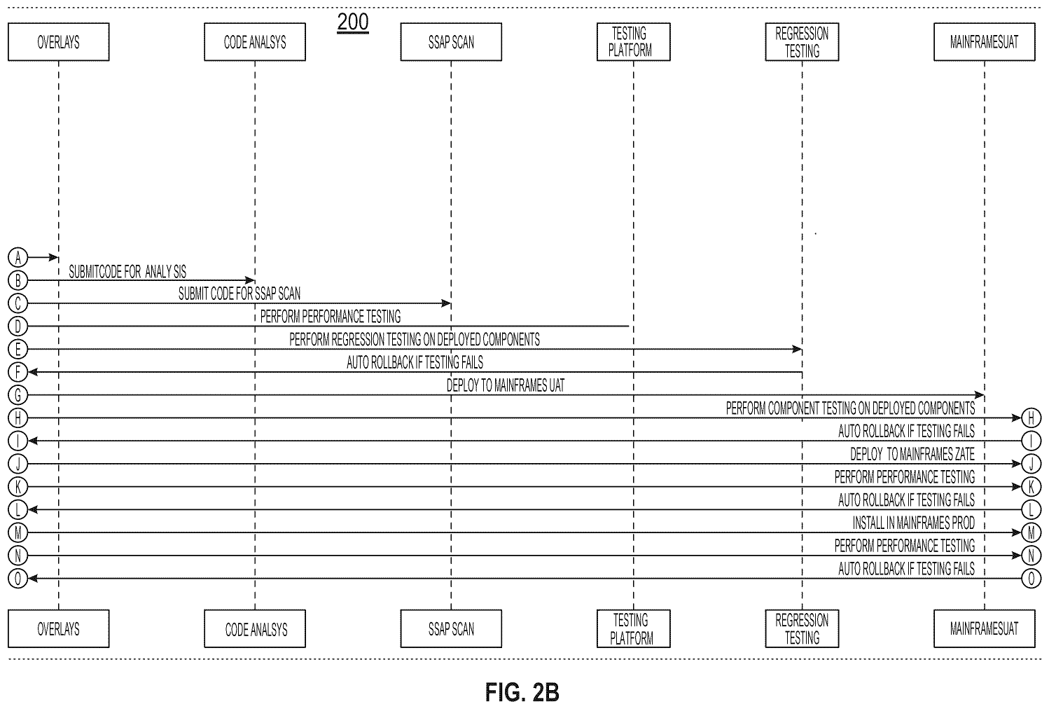

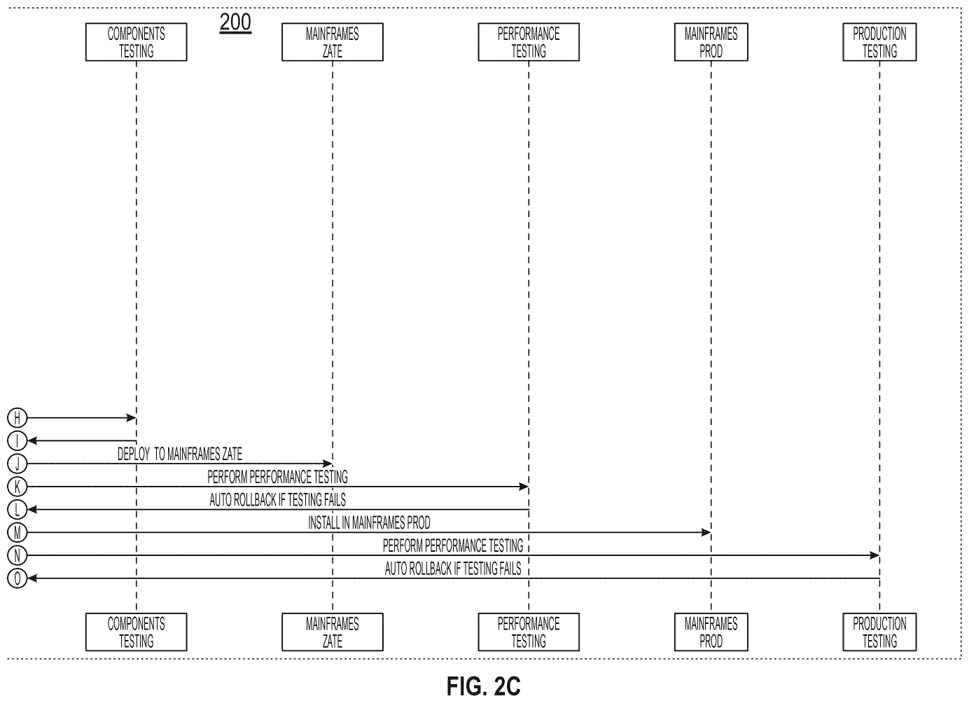

FIGS. 2A-2C is a sequential flow diagram 200 of a mainframe DevOps in a pipeline in accordance with the embodiments of the present disclosure. Step 202 developers commit stage changes in the mainframe.

At the change request system, step 204 checks for staged components. Step 206 provides the component list. Step 208 checks for staged components.

At the CodeTracker, step 210 check in the staged components.

At the code repository, step 212 triggers the pipeline.

At the CI/CD pipeline, step 214 connects to the mainframes to submit deployments. Step 216 deploys to the mainframe QA. Step 218 submits code to for security testing (e.g., Sonar analysis). Step 220 submits the code for security testing (e.g., SSAP). Step 222 performs Performance Testing. Step 224 performs regression testing on deployed components. Step 226 performs auto rollback if the testing fails. Step 228 deploys to the mainframe UAT. Step 230 performs component testing on deployed components. Step 232 performs auto rollback if the testing fail. Step 234 deploys to the mainframe zATE. Step 236 performs Performance Testing. Step 238 performs auto rollback if the testing fail. Step 240 installs the mainframe production (PROD). Step 242 performs Production Testing. Step 244 performs auto rollback if the testing fail.

At the zOSAPI, step 246 deploys to the mainframe QA. Step 248 checks for overlays.

It will be appreciated that although FIGS. 2A-2C show sequential sequences of operation, this is merely for understanding and it is possible for some of these operations to be implemented in a different order. Hence, it is not essential to perform the exact method of FIGS. 2A-2C.

FIG. 3 is a high-level overview of an exemplary mainframe pipeline 300 in accordance with the embodiments. The exemplary workflow as depicted in the embodiment of FIG. 3 may include as stage 1, code build 102 using, for example, Jules. After stage 1, the workflow may precede to code scan 104 (stage 2), code deploy 106 (stage 3), code test 108 (stage 4), and code roll back 110 (stage 5).

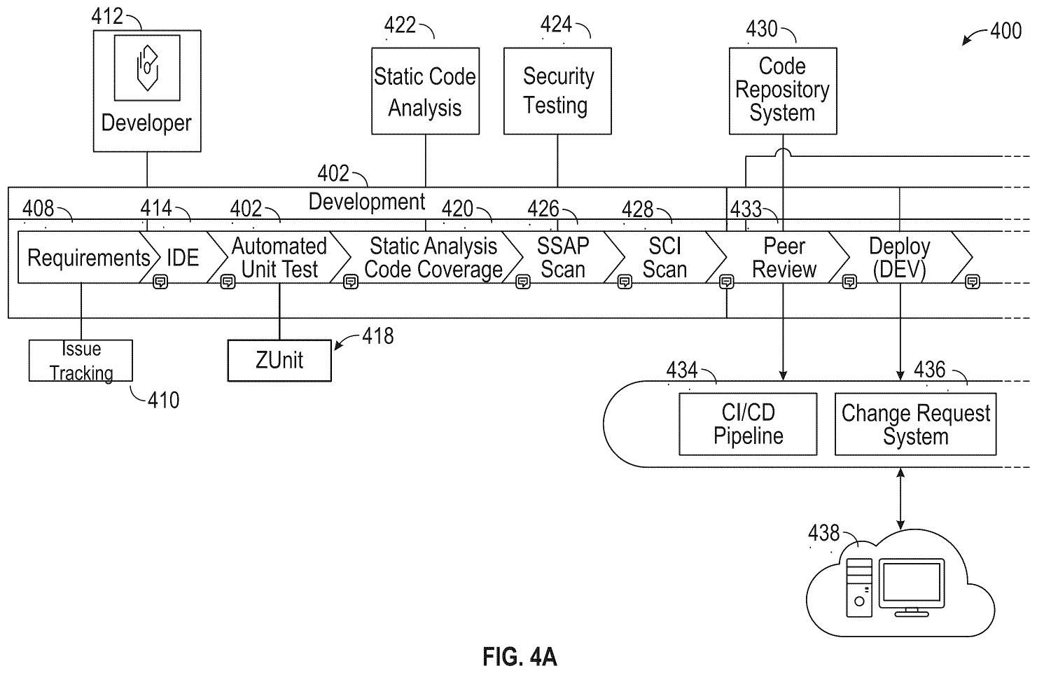

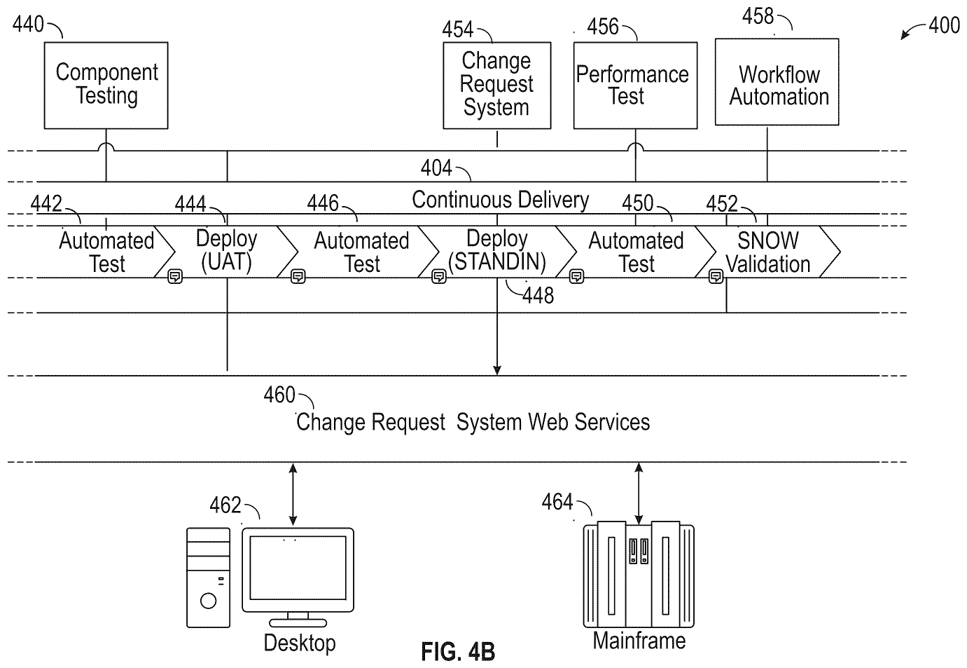

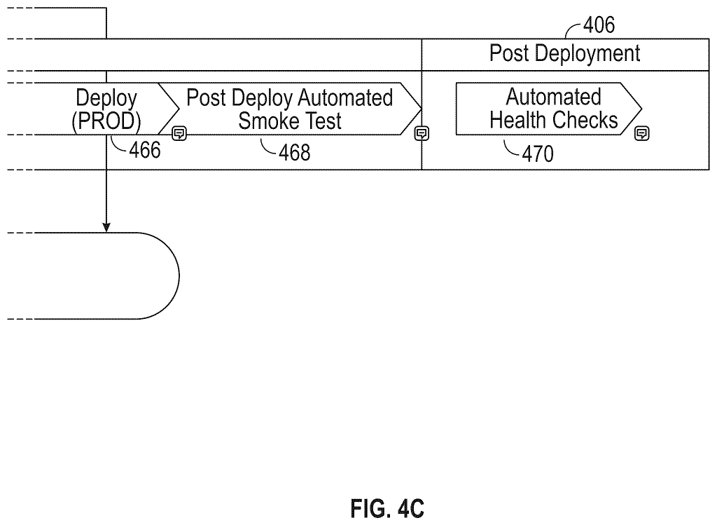

FIGS. 4A-4C is a simple workflow diagram 400 of a mainframe DevOps pipeline 400 in accordance with the embodiments. As shown in the exemplary embodiment, key components of the workflow diagram may consist of several phases: a development phase 402, a continuous delivery phase 404, and a post-delivery phase 406. Each phase has its own set of activities as illustrated in FIGS. 4A-4C.

The pipeline 400 of the mainframe may include the same or similar processes as described above with regard to the pipeline 100 of FIG. 1 and the mainframe pipeline 300 in FIG. 3. FIG. 4 is an exemplary embodiment of a mainframe DevOps pipeline. There is no standard format for a pipeline and can differ by organization and application. While there is no standard DevOps pipeline, most pipelines use similar fundamental components. The pipeline 400 can include build automation continuous integration, automation testing, validation, and reporting.

The pipeline 400 streamlines the processes of coding, testing, and deploying applications by providing teams a single repository to store their work, along with the automation tools to consistently and frequently integrate, test, and deploy the code to production. Each step is evaluated for success before moving to the next stage of the pipeline. In the event of a failure, the pipeline 400 is stopped, and feedback is provided to the developer.

In FIG. 4, the development phase 402 of the pipeline 400 begins with gathering the requirements 408. The requirements 408 documentation defines all the features and functionalities that the product should include, and also describe how it should operate. The requirements 408 are created at the very beginning of the process by the customer and/or product owner, as it constitutes the point of reference in the end, and also helps the customers understand what they can expect from the final release.

An issue tracking tool 410, such as JIRA, can be used for tracking the requirements 408, defects, and task as part of software development.

In the development phase 402, code can be created or updated by developers 412 and then pushed to a version control system or a code repository where it is centrally stored and managed. This ensures that every modification made to the code is tracked and can be retrieved or reverted, providing a safety feature for developers 412.

The developer 412 can use an integrated development environment (IDE) 414 to write and test the code efficiently. The IDE 414 is a software application that can combine many tools to increase the developer's productivity by combining capabilities, such as software editing, building, testing, and packaging in an easy-to-use application.

Another aspect of the development phase 402 is the execution of preliminary tests, often automated unit test 416 and static code analysis 420. These tests focus on individual components of the application to ensure that the code's basic correctness and quality are upheld. If these tests fail, the pipeline 400 execution halts and the developers 412 are notified. This early detection and correction saves time and resources in the software development lifecycle.

Automated unit testing 416 is the process where the smallest functional unit of code, for example, a software code component, is tested. The automated unit testing 416 can be performed, for example, by z/OS Automated Unit Testing Framework (ZUnit) 418 provided by IBM. The ZUnit 418 provides an automated solution for recording, running, and verifying unit test cases that are written by using the ZUnit framework. The ZUnit 418 provides several tools for creating test cases, recording test case data, and running test cases.

Static code analysis 420 (also known as static analysis) is a software testing methodology that analyzes code without executing it and reports any issue. The static code analysis 420 can find code defects by examining the code without executing the program. The process can provide an understanding of the code structure and can help ensure that the code adheres to industry standards. Static code analysis 420 can be used to identify potential vulnerabilities, errors, and deviations from coding standards early in the development process 402. Static code analysis tools 422 can use techniques like syntax analysis, data flow analysis, and security analysis. The pipeline 400 can include, for example, code analysis tools 422, such as SonarQube®, ReSharper®, CodeClimate®, CAST Highlight®, and Codacy®. These platforms are designed to analyze source code and identify potential issues.

Once the code passes the static tests 420, the pipeline 400 passes the code for scanning for security issues 424 as depicted in FIGS. 1 and 3. The security analysis 424 can be used for analysis to detect and fix issues, such as vulnerabilities that are security-related issues that represent a backdoor for attackers, bugs that represent issues which are wrong in the code and need to be fixed, code smells which are not errors and the code still works but impedes maintaining the code, and duplications. The security analysis 424 can help detect a broad range of security issues such as SQL injection vulnerabilities, cross-site scripting (XSS) code injection attacks, buffer overflows, authentication issues, and cloud secrets detection. For example, code analyzers that can be employed in the present disclosures include, for example SonarQube®, which can detect tricky bugs including null-pointer dereferences, logic errors, and resource leaks, for more than 20 coding languages. For the issues reported from the security testing 424, the pipeline 400 can be configured to filter out the problems that are reported during the security testing 424.

The pipeline scan can be directly embedded or linked into the development phase 402 using a pipeline scanning tool 426, 428, and the scanning can be configured to run based on various triggers, such as commits, merge requests or code builds. The security analysis 424 can use a scanning tool 426, 428 to break the build process based on the severity and category of flaw detected. The scanning tools 426, 428 can evaluate the change in results compared to previous scans to identify security flaws in the code before the code is released into the production environments.

Any suitable scanning tool may be used in accordance with various embodiments of the present disclosure. For example, the suitable scanning tool may include a Software Security Assurance Process (SSAP) scan 426 and a security inspection code (SIC) scan 428.

The SSAP scan 426 can be configured to ensure that the software code is designed to operate at a level of security that is consistent with the potential harm. The SSAP scan 426 can identify and categorize the information in the software code according to, for example, the lowest category to a top category which may have an irreparable impact. The lowest category can be pre-defined as having a minimal impact, and the top category can be pre-defined, for example, as having a threat to human life, having an irreparable impact, or resulting in significant losses.

The SIC scan 428, also known as a secure code review, is a process that examines source code for security vulnerabilities. The goal is to identify and fix security issues before they can be exploited by attackers. Secure code review is an automated process that examines an application's source code. The goal of this examination is to identify any existing security flaws or vulnerabilities. Code review specifically looks for logic errors, examines spec implementation, and checks style guidelines, among other activities.

After the development phase 402, the continuous delivery phase 404 ensures that every change to the codebase is automatically put through a series of tests and, if successful, can be deployed to a staging or production environment. Once the code passes the static tests, automated stages of the pipeline 400 package and compile the code for further automated testing in the development phase 402. In embodiments, the pipeline 400 employs a version control system that tracks changes so that the past versions and the current version of the code being used are known.

Embodiments may include an automated change request system 436, such as ChangeMan, which is a software configuration management tool used by developers 412 to manage and track changes to software development projects. The automated change request system 436 allows developers to manage source code changes, track project progress, and collaborate with team members on software development projects.

In various embodiments, the lines of code that are being changed or revised can be pulled from a cloud service provider 438, a desktop computer 462, and/or a mainframe computer 464 running, for example, z/OS and pushed into a distributed applications source code repository system 430, such as Bitbucket or GitHub. Once the component code is pushed to the code repository 430, this triggers an orchestration tool 434. An orchestration tool 434, such as Jules, can be used to ensure that the pipeline 400 stages are triggered automatically, based on predefined events, conditions, or dependencies. For example, a web hook in the orchestration tool may automatically trigger the pipeline 400 when the orchestration tool identifies code is committed in the code repository 430. In an embodiment, the code commit can be synchronized with the code repository 430 to trigger the pipeline 400.

A peer review process 432, also known as code reviews or design reviews, may be provided in an embodiment. Some conventional source code management tools, such as ChangeMan, do not provide a peer review process. In the present disclosure, the peer review process 432 for the mainframe pipeline 400 compares the code developed with existing code for any conflict.

In embodiments, the peer review process 432 can be implemented as a strategy for ensuring code quality and identifying issues early to prevent them from becoming more significant problems throughout the pipeline 400. The peer review process 432 can involve multiple steps and leverage various tools and applications. First, the developer who completes a task can initiate a review request using an issue tracking tool, such as JIRA. The review request can be assigned to one or more team members for review. A version control system, such as GitHub, can be utilized to manage code repositories 430 and facilitate the review process.

Once the peer review process 432 is completed, the developer can address the feedback received and make the necessary modifications. The peer review process 432, supported by tools such as code repository system 430 (e.g., Bitbucket, GitHub) an orchestration tool 434 (e.g., Jules), and a software change management tool 436 (e.g., ChangeMan) provide for seamless code integration and automated testing to ensure that the code changes do not introduce any new issues. The functionalities of these tools can be accessed through the use of a software change management web services 460, such as ChangeMan Web Services. In an embodiment, the ChangeMan Web Services application server may run on any desired operating system platform, including z/OS, Windows, Linux, or Solaris.

After the peer review process 432, deploy stage 433 may be provided in an embodiment to deploy the packages to the next stage. Testing and QA is one of the software deploy tools which help to maintain a desired level of quality in a service or product to deliver consistent results by using agreed standard processes and procedures to ensure the software meets certain requirements before being released.

Various embodiments may employ a zOSMF deploy connector for a mainframe computer running z/OS. The pipeline 400 may connect to the mainframes over ChangeMan Web Services 460 and identify components to be promoted via a zOSMF deploy connector solution. The pipeline 400 promotes code to higher environments via the zOSMF deploy connector solution.

Automated component testing 440 can be integrated into the continuous delivery phase 404 of the pipeline 400. This allows for frequent testing and immediate feedback. The code deploy stage 433 may include the component testing 440. Component testing 440 is a level of software testing that focuses on verifying the individual components of a system.

Component testing 440 may use, for example, SmartSpec, Kibana, and Selenium, in the mainframe pipeline 400, to verify the functionality of individual parts of the application in isolation. By automating component tests 440 within the pipeline 400, developers can continuously assess the impact of changes, ensuring that each component meets its specifications before progressing to broader system integrations. This approach enhances the overall quality and robustness of the software.

Automated tests can be executed repeatedly in the continuous delivery phase 404, as implemented in automated tests 442, 446, 450 to ensure that the code components continue to function correctly after modifications.

The pipeline 400 is a continuous process that automatically deploys in the UAT stage 444 every code change that passes the continuous delivery process to production. During the deployment of the UAT stage 444, the software is tested by the intended audience to make sure that the software can handle real-world functions and meet the user's expectations. In the UAT stage 444, users are given the opportunity to interact with the software before its official release to determine if any features have been overlooked or if it contains any bugs or errors.

As understood by one of skill in the art, a stand-in deployment deploy (STANDIN) 448 may serve as a placeholder while the final version of the application is being prepared or validated. This ensures that the CI/CD pipeline continues to function and that the environment is ready for the final deployment.

In one or more embodiments, a change request system 454, within the context of the pipeline 400, is a structured process and toolset used to manage and track requests for changes to the software, its environment, or its configurations. This system ensures that all changes are documented, reviewed, approved, and implemented in a controlled manner to maintain the integrity and performance of the software. When combined with the deploy (STANDIN) 448, the change request system 454 helps facilitate testing and validation of changes before they are applied to the pipeline 400.

Performance testing 456 may be used in an embodiment of the pipeline 400. Performance testing 456 ensures reliability and efficiency of the code component. It involves simulating the real world usage scenarios to identify potential bottlenecks and optimize throughput and response times for the commit code. For example, the performance testing 456 may be performed using Blazemeter.

A workflow automation tool 458, such as ServiceNow (SNOW), can be integrated into the pipeline 400 to enable teams to use workflows to automate interactions (e.g., requests, approvals, forms, scripts, etc.) and visualize the sequence of tasks via simple flowcharts, helping to ensure tasks are completed correctly and efficiently. The workflow automation tool 458, using a SNOW ticket, can track the deployment of the pipeline. The workflow automation tool 458 can provide the pipeline 400 the ability to create or update an issue ticket as many times as needed during the execution of the pipeline, stage, or deployment workflow.

In an embodiment, the workflow automation tool 458 can be configured to restrict code commits such that only validated and approved pull requested are allowed to merge or integrate into the existing code. For example, a SNOW validation 452 can be utilized to validate that the new code does not break the existing code. The deploy (production) stage 466 deploys every code commit to the production environment. The deploy (production) stage 466 automatically deploys each validated code commit to the production. In the continuous deployment stage 466, the code commit automatically deploys as soon as the code passes the suite of automated testing 442, 446, 450 in the continuous delivery phase 404.

A post-deployment smoke test 468 may be used to implement a set of tests that evaluate an application's stability and functionality after it has been deployed. The post-deployment smoke test 468 may be utilized in a scenario where the code is run through the pipeline and all of the tests pass, but, when the code is deployed to a live production target environment, the code does not function as expected. Because what will happen when the application is pushed live cannot always be predicted, the smoke tests 468 can provide a solution to reveal these types of failures by running test cases that cover the critical components and functionality of the application. The smoke tests 468 ensure that the application will function as expected in a deployed scenario.

In the post-deployment phase 406, health checks 470 are provided as automated tests that verify the health of an application after a deployment is complete. After the successful new deployment of an application, post-deployment health checks 470 can verify whether the application meets its performance, security, and functional expectations, as well as whether it has correctly handled any infrastructure or configuration changes. Post-deployment health checks 470 may include automated testing, monitoring of application logs and metrics, and verification of incident response and disaster recovery processes.

Pipelines 400 that utilize continuous deployment can implement a rollback process to ensure that a previous stable version can be redeployed in the event of unexpected issues with the newly deployed version.

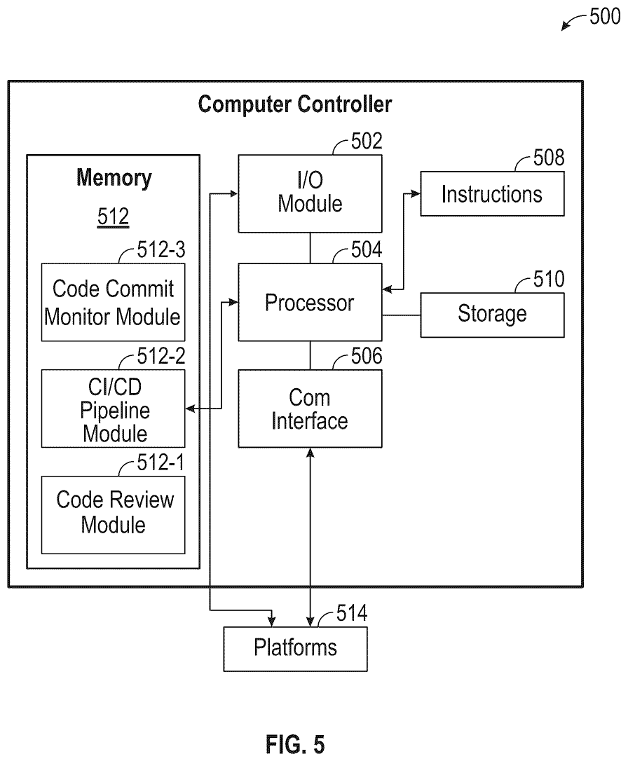

In the embodiments, FIG. 5 illustrates a computer controller 500 that may be an application-specific hardware, software, and firmware implementation of the mainframe pipeline processes depicted in FIGS. 1-4, described above. The controller 500 may include a processor 504 configured to be executed on one or more, or all the blocks of the system of FIGS. 1-4, described above.

The processor 504 can have a specific structure imparted to the processor 504 by instructions stored in the memory 512 and/or by instructions 508 fetchable by the processor 504 from a storage medium 510. The storage medium 510 can be remote and communicatively coupled to the controller 500.

The controller 500 can be a stand-alone programmable system, or a programmable module included in a larger system. For example, the controller 500 may include or be connected with external computer systems. For example, the controller 500 may include one or more hardware and/or software components configured to fetch, decode, execute, store, analyze, distribute, evaluate, and/or categorize information.

The processor 504 may include one or more processing devices or cores (not shown). In some embodiments, the processor 504 may be a plurality of processors, each having one or more cores. The processor 504, in another embodiment, may be a distributed processor. The processor 504 can execute instructions fetched from the memory 512, i.e., with reference to, among other code, instructions or data, one of memory modules 512-1, 512-2, or 512-3. Alternatively, the instructions can be fetched from the storage medium 510, or from a remote device connected to the controller 500 via the communication interface 506.

Furthermore, the communication interface 506 can also interface with processors within a computer system of the mainframe pipeline architecture. An input/output (I/O) module 502 may be configured for additional communications to or from associated local and/or remote systems of one or more platforms 514, such as the mainframe pipeline process of FIGS. 1-4.

Without loss of generality, the storage medium 510 and/or the memory 512 can include a volatile or non-volatile, magnetic, semiconductor, tape, optical, removable, non-removable, read-only, random-access, or any type of non-transitory computer-readable computer medium. The storage medium 510 and/or the memory 512 may include programs and/or other information usable by processor 504. Furthermore, the storage medium 510 can be configured to log data processed, recorded, or collected during the operation of the controller 500.

The data may be time-stamped, location-stamped, cataloged, indexed, encrypted, and/or organized in a variety of ways consistent with data storage practice. The memory modules in memory 512 may represent specialized modules for various functions described in the embodiments herein.

By way of example, the memory module 512-1 may represent a specialized module configured to implement aspects of the code review process described above. Similarly, the memory module 512-2 may form a specialized CI/CD pipeline trigger module, and the memory module 512-3 may form a specialized code commit module, as described with reference to one or more of FIGS. 1-4, described above. The instructions embodied in these memory modules can cause the processor 504 to perform certain operations consistent with the functions described above.

The processor 504 is a hardware device for executing software, particularly that stored in memory 512. The processor 504 can be any custom made or commercially available processor, a central processor unit (CPU), an auxiliary processor among several processors associated with the computer controller 500, a semiconductor based microprocessor (in the form of a microchip or chip set), a macroprocessor, or generally any device for executing software instructions.

The memory 512 can include any one or combination of volatile memory elements (e.g., random access memory (RAM, such as DRAM, SRAM, SDRAM, etc.)) and nonvolatile memory elements (e.g., ROM, erasable programmable read-only memory (EPROM), electronically erasable programmable read-only memory (EEPROM), programmable read-only memory (PROM)).

Memory 512 may also include removable storage such as tape, compact disc read-only memory (CD-ROM), disk, diskette, cartridge, cassette or the like, etc., and non-removable storage such as a hard disk drive (HDD).

Moreover, the memory 512 may incorporate electronic, magnetic, optical, and/or other types of storage media. Note that the memory 512 can have a distributed architecture, where various components are situated remote from one another, but can be accessed by the processor 504.

The software in memory 512 may include one or more separate programs, each of which comprises an ordered listing of executable instructions for implementing logical functions, and a suitable operating system (OS). The OS essentially controls the execution of the computer programs, and provides scheduling, input-output control, file and data management, memory management, and communication control, and related services.

If the computer controller 500 is a PC, workstation, intelligent device or the like, the software in the memory 512 may further include a basic I/O system (BIOS), omitted from this description for simplicity. The BIOS is a set of essential software routines that initialize and test hardware at startup, start the OS, and support the transfer of data among the hardware devices. The BIOS is stored in read-only memory (ROM) so that the BIOS can be executed when the computer controller 500 is activated.

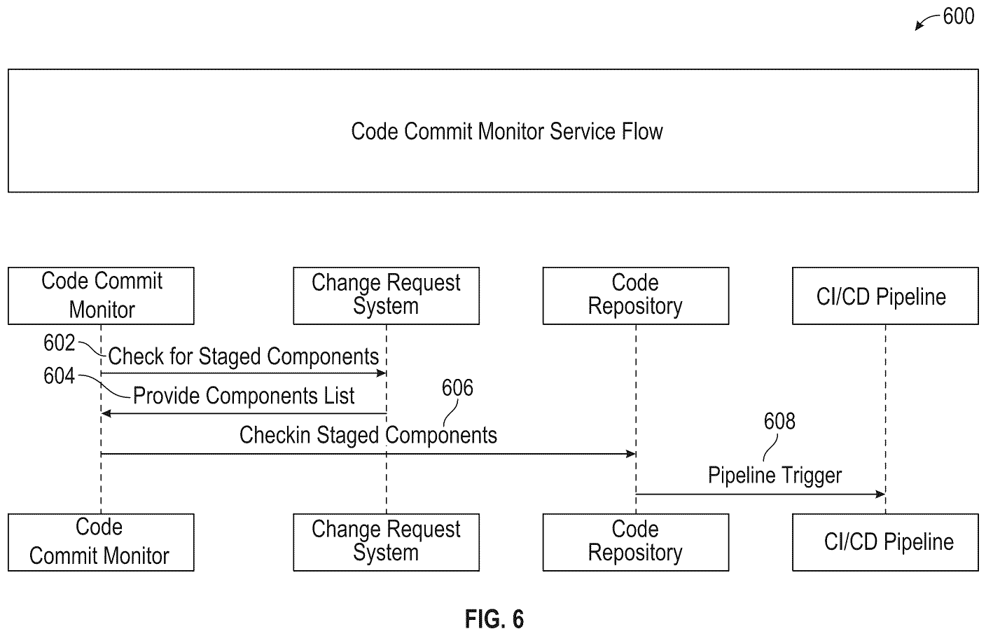

FIG. 6 is an exemplary code tracker service flow diagram 600 in accordance with the embodiments. At the CodeTracker to the change request system, step 602 checks for staged components, and step 604 provides a components list. At the Code Tracker to the code repository, step 606 checks in the staged component. At step 608, the CI/CD pipeline is triggered after code is committed to the code repository.

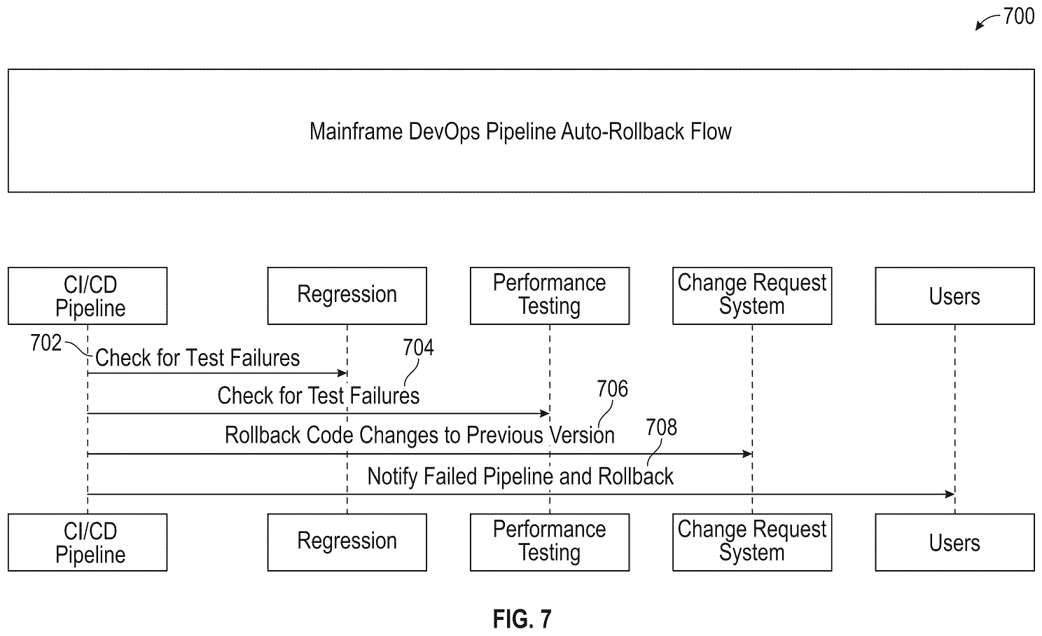

FIG. 7 is an exemplary mainframe DevOps pipeline auto-rollback flow 700 in accordance with the embodiments. At the CI/CD pipeline to the registration, step 702 checks for test failure. At the CI/CD pipeline to the performance testing, step 704 checks for test failures. At the CI/CD pipeline to the change request system, step 706 rollbacks code changes to the previous version. At the CI/CD pipeline to the user, step 708 notifies the user of failed pipeline and rollbacks.

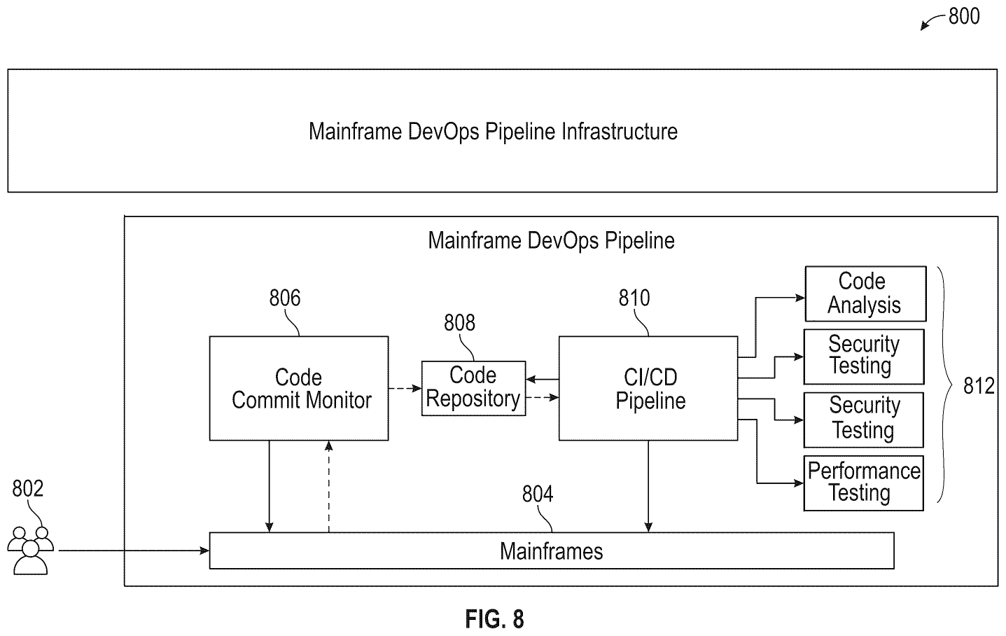

FIG. 8 is an exemplary mainframe DevOps pipeline infrastructure diagram 800 in accordance with the embodiments. In general, the CI/CD mainframe pipeline infrastructure 800 provides a development practice that involves regularly merging code changes from multiple contributors into a shared repository. The primary goal is to detect and address integration issues early in the development process. Automated builds and tests are key components to ensure that the codebase of the mainframe is always in a functional state.

The mainframe pipeline infrastructure 800 also automates the delivery process, allowing for the rapid and reliable release of software. This ensures that every change to the codebase is automatically put through a series of tests and, if successful, can be deployed to a staging or production environment.

FIG. 8 illustrates an exemplary embodiment of some of the key components of the mainframe pipeline infrastructure 800. Developers 802 commits code to make changes to the codebase in a mainframe 804 to introduce new features, fix bugs, or enhance existing functionalities. Code tracker 806 monitors the mainframe 804 for changes in the code and identify the component code being updated by the code commit. The revised code is pushed by the code tracker 806 to a version control system or a code repository 808 where it is centrally stored and managed.

An orchestration tool 810 can be used to ensure that the pipeline stages are triggered automatically, based on predefined events, conditions, or dependencies. For example, when the orchestration tool 810 identifies code is committed in the code repository 808, the orchestration tool 810 automatically triggers the pipeline. The CI/CD pipeline automatically triggers a build process, compiling the code and creating an executable or deployable artifact.

Automated tests 812, including security tests, performance tests, unit tests, integration tests, and other relevant tests, are conducted in the orchestration tool 810 environment to ensure the code changes function as intended. If all tests pass successfully, the changes are merged into the main codebase. This ensures that the main code remains in a continuously functional state.

If a test fails, an issue is detected, indicating that the code changes may have introduced a bug or a compatibility issue, a roll back may occur to demote the code to the previous release. Developers review the test results, identify the root cause of the issue, and make the necessary corrections to the code. Then, re-testing occurs. The corrected code is pushed back into the CI/CD pipeline, initiating a new round of testing to ensure the issues have been addressed. Once all tests pass successfully, the changes are merged into the main codebase. The corrected code is then deployed to the production environment, ensuring that only stable and validated changes make it to the live system.

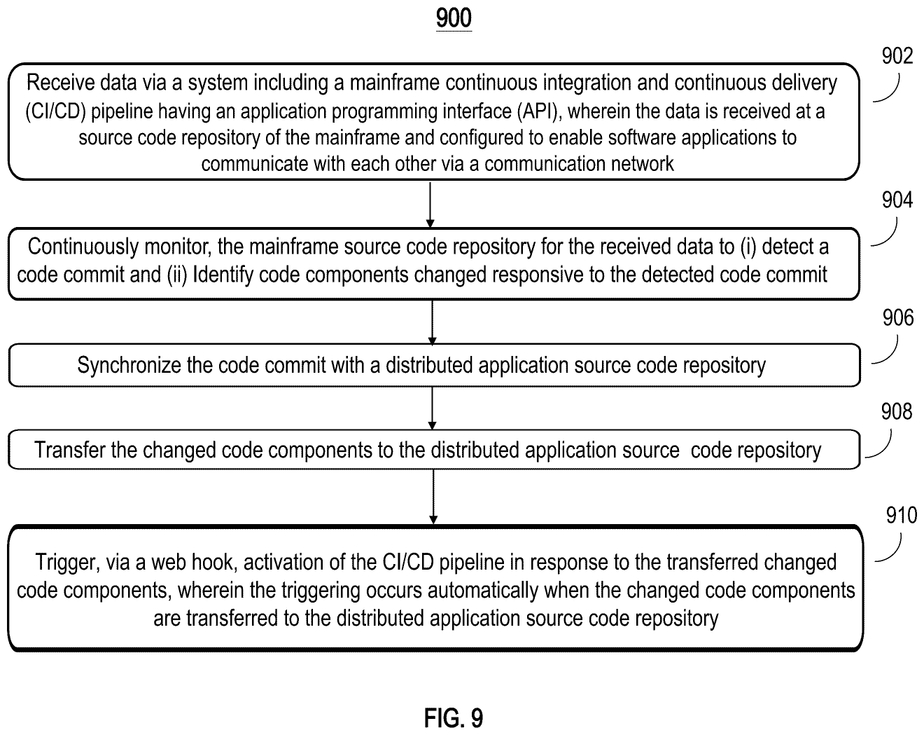

FIG. 9 is a flow chart of an exemplary method 900 of implementing an embodiment of the present disclosure. The method 900 includes step 902, where data is received, via a system implementing a mainframe CI/CD pipeline including an API written data is received at a source code repository of the mainframe and configured to enable software applications to communicate with each other via a communication network.

An example CI/CD pipeline 120 is described in the discussion above associated with FIG. 1. Other examples of the CI/CD pipeline are provided in the descriptions that accompany FIG. 2A, the mainframe pipeline 300 depicted in FIG. 3, and the CI/CD pipeline 810 depicted in FIG. 8.

In step 904 mainframe source code repository for the received data is continuously monitored to (i) detect a code commit and (ii) identify code components changed responsive to the detected code commit. A mainframe source code repository 113 is described above and depicted in FIG. 1. An example code commit monitor 114 is also depicted in FIG. 1 and described above. Other examples of the code commit monitor are provided in reference to the code commit monitor depicted in FIG. 2A, the code commit monitor service flow 600 depicted in FIG. 6, and the code commit monitor 806 depicted in FIG. 8.

In step 906, the co-commit synchronized with a distributed application source code repository and, in step 908 the changed code components are transferred to a distributed application source code repository, such as the exemplary distributed code repository 118 described with reference to FIG. 1. Other examples of the distributed code repository are provided in the descriptions above with reference to FIG. 2A, FIG. 4A, and FIG. 6.

In step 910, the CI/CD pipeline is activated via a web hook in response to the transferred code components. The activation of the CI/CD pipeline occurs automatically when the changed code components are transferred to the distributed application source code repository, as described with reference to FIG. 1. A description of the triggering process is provided above, with reference to FIG. 1. Other examples of the triggering process are described in reference to the trigger pipeline 212 depicted in FIG. 2A, and the pipeline trigger 608 depicted in FIG. 6.

Embodiments of the present disclosure provide a comprehensive approach to automating the CI/CD pipeline specifically for mainframe environments, which traditionally rely on manual and time-consuming processes. Additional aspects of the embodiments include:
1. Automated code segregation and transfer: The system's ability to automatically identify, segregate, and transfer code components based on differences in the code is a significant advancement. This ensures that only the necessary components are processed, reducing the risk of errors and improving efficiency.
2. Integration with mainframe and distributed systems: The disclosure bridges the gap between mainframe and distributed systems by updating code components in a distributed version control system upon detecting code commits in a mainframe version control tool. This seamless integration is crucial for modernizing legacy systems.
3. Comprehensive automated testing: The system incorporates various automated testing methodologies, including unit testing, security testing, performance testing, and end-to-end testing. This ensures that the code is thoroughly vetted at each stage of the pipeline, enhancing reliability and security.
4. Automated rollback mechanisms: The inclusion of an automated rollback feature that reverts changes made to the code components when testing fails is a critical innovation. This ensures system stability and minimizes downtime by quickly restoring the system to a known stable state.
5. Password-less connection using certificate-based authentication: Establishing a password-less connection throughout the CI/CD pipeline using certificate-based authentication enhances security and simplifies the authentication process, which is particularly important in highly regulated industries like finance.
6. Code review and conflict detection: The system's ability to perform a code review process to compare newly developed code with existing code to detect conflicts is a novel feature. This helps maintain code quality and consistency across the development lifecycle.

The aforementioned features collectively address the critical issues faced in mainframe software development and deployment, such as slow time-to-market, inefficiency, lack of standardization, and difficulty in compliance and auditing. By automating and streamlining the CI/CD pipeline, the disclosure significantly enhances efficiency, reduces errors, ensures compliance, and speeds up the time-to-market for new features and updates.

Embodiments may be provided as a computer program product including a non-transitory computer and/or monitored machine-readable medium having stored thereon instructions that may be used to program a computer (or other electronic device) to perform processes described herein. For example, a non-transitory computer-readable medium may store instructions that, when executed by a processor of a computer system, cause the processor to perform certain methods disclosed herein.

Further, in an exemplary embodiment, communication via network may be facilitated by networking devices including, but not limited to, multiplexers, routers, hubs, gateways, firewalls, and switches. In some embodiments, intelligent devices and network devices may comprise physically distinct devices. In other embodiments, intelligent devices and network devices may be composite devices, or may be configured in a variety of ways to perform overlapping functions. Intelligent devices and network devices may comprise multi-function hardware (e.g., processors, computer-readable storage media, communications interfaces, etc.) that can be utilized to perform a variety of tasks that pertain to network communications and/or to operation of equipment within a system.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the disclosure has been described with reference to particular means, materials and embodiments, the disclosure is not intended to be limited to the particulars disclosed, rather the disclosure extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “disclosure” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A system that implements a mainframe continuous integration and continuous delivery (CI/CD) pipeline development, the system comprising:
an application programming interface (API) configured to receive data at a mainframe source code repository to enable software applications to communicate with each other via a communication network; and
a processor, coupled to a memory component and the API, wherein the processor is configured to:
continuously monitor the mainframe source code repository for the received data to (i) detect a code commit and (ii) identify code components changed responsive to the code commit;
synchronize the code commit with a distributed application source code repository;
transfer the changed code components to the distributed application source code repository; and
trigger, via a web hook, activation of the CI/CD pipeline in response to the transferred changed code components;
wherein the triggering occurs automatically when the changed code components are transferred to the distributed application source code repository.

2. The system of claim 1, wherein the CI/CD pipeline includes multiple stages; and wherein the processor is further configured to:
segregate, at the distributed application source code repository, the code components into at least a first group and a second group, each group having different components; and
perform, at each of the multiple stages, a specific operation on the at least first and second groups as the at least first and second groups are transferred through the CI/CD pipeline.

3. The system of claim 1, wherein the processor is further configured to automatically perform testing for deployment;
perform an automated rollback to revert changes made to the code components when the testing fails; and
establish a password-less connection throughout the CI/CD pipeline using certificate-based authentication.

4. The system of claim 2, wherein the processor is further configured to monitor code commits in a mainframe version control tool using a code commit monitor microservice.

5. The system of claim 4, wherein the processor is further configured to update the code components in a distributed version control system upon detecting code commits.

6. The system of claim 5, wherein the processor is further configured to perform a code review process to compare code developed in the CI/CD pipeline with existing code to determine whether a conflict exists.

7. The system of claim 6, wherein the processor is further configured to perform a unit test to test the code components to verify that the changes to the code operate correctly before incorporating the code into a computing system.

8. The system of claim 7, wherein the processor is further configured to perform a security test to continuously inspect the code components to identify potential threats.

9. The system of claim 8, wherein the processor is further configured to perform a performance test to test every functionality of the code components to verify that an application performs correctly.

10. A method for implementing a mainframe continuous integration and continuous delivery (CI/CD) pipeline, the method comprising:
receiving data at a mainframe source code repository via an application programming interface (API) configured to enable software applications to communicate with each other via a communication network;
continuously monitoring the mainframe source code repository for the received data to (i) detect a code commit and (ii) identify code components changed responsive to the code commit;
synchronizing the code commit with a distributed application source code repository;
transferring the changed code components to the distributed application source code repository; and
triggering, via a web hook, activation of the CI/CD pipeline in response to the transferred changed code components;
wherein the activating occurs automatically when the changed code components are transferred to the distributed application source code repository.

11. The method of claim 10, further comprising:
segregating, at the distributed application source code repository, the code components into at least a first group and a second group, each group having different components; and
performing, at each of multiple stages of the CI/CD pipeline, a specific operation on the at least first and second groups as the at least first and second groups are transferred through the CI/CD pipeline.

12. The method of claim 11, further comprising establishing a password-less connection throughout the CI/CD pipeline using certificate-based authentication; and
monitoring code commits in a mainframe version control tool using a code commit monitor microservice.

13. The method of claim 12, further comprising updating the code components in a distributed version control system upon detecting code commits.

14. The method of claim 13, further comprising performing a code review process to compare code components developed in the CI/CD pipeline with existing code to determine whether a conflict exists.

15. The method of claim 14, further comprising performing a unit test to test the code components to verify that the changes to the code components operate correctly before incorporating the code into a computing system.

16. The method of claim 15, further comprising performing a security test to continuously inspect the code components to identify potential threats from unauthorized access, data breaches, and other security issues.

17. The method of claim 16, further comprising performing a performance test to test every functionality of the code components to verify that an application performs correctly in real-world scenarios.

18. A non-transitory computer-readable medium storing instructions that, when executed by a processor, cause the processor to implement a mainframe continuous integration and continuous delivery (CI/CD) pipeline, the instructions comprising:
receiving data at a mainframe source code repository via an application programming interface (API) configured to enable software applications to communicate with each other via a communication network;
continuously monitoring the mainframe source code repository for the received data to (i) detect a code commit and (ii) identify code components changed responsive to the code commit;
synchronizing the code commit with a distributed application source code repository;
transferring the changed code components to the distributed application source code repository; and
triggering, via a web hook, activation of the CI/CD pipeline in response to the transferred changed code components;
wherein the activating occurs automatically when the changed code components are transferred to the distributed application source code repository.

19. The non-transitory computer-readable medium of claim 18, wherein the instructions further cause the processor to automatically perform testing for deployment.

20. The non-transitory computer-readable medium of claim 19, wherein the instructions further cause the processor to:
perform an automated rollback to revert changes made to the code components when the testing fails; and
monitor code commits in a mainframe version control tool using a code commit monitor microservice.
